(19) United States
(12) Patent Application Publication
(10) Pub. No.: US 2012/0324876 A1
(43) Pub. Date: Dec. 27, 2012

(54) SUBSEA ACCUMULATOR SYSTEM

(75) Inventors: James Edward Fuselier, Mamou, LA (US); Daniel Gutierrez, Houston, TX (US); Luis Javier Gutierrez, Houston, TX (US)

(73) Assignee: BP Corporation North America Inc., Houston, TX (US)

(21) Appl. No.: 13/457,260

(22) Filed: Apr. 26, 2012

Related U.S. Application Data
(60) Provisional application No. 61/479,308, filed on Apr. 26, 2011.

(51) Int. Cl. F16D 31/00

(52) U.S. Cl. 60/327; 60/413

(57) ABSTRACT

Embodiments of a subsea accumulator system are disclosed. The system includes a subsea skid structure, a pre-charged fluid accumulator mounted in the subsea skid structure and fluidly coupled to a flowline in the skid structure, and a subsea device coupled to the flowline to receive hydraulic fluid power from the pre-charged fluid accumulator. The system may include a fill port having a releasable connection to selectively couple with a hydraulic fluid supply separate from the skid structure. Certain embodiments may include a subsea pump, instead of a pre-charge, for delivering pressurized fluid to a piston in the accumulator, and multiple accumulators for mixing fluids or discharging the fluids sequentially.

### CROSS-REFERENCE TO RELATED APPLICATIONS

The present application claims priority to provisional patent application No. 61/479,308 filed Apr. 26, 2011, entitled “Subsea Accumulator System.”

### BACKGROUND

In offshore drilling operations, a blowout preventer (BOP) is installed on a wellhead at the sea floor and a lower marine riser package (LMRP) is mounted to the BOP. In addition, a drilling riser extends from a flex joint at the upper end of LMRP to a drilling vessel or rig at the sea surface. A drill string is then suspended from the rig through the drilling riser, LMRP, and the BOP into the well bore. A choke line and a kill line are also suspended from the rig and coupled to the BOP, usually as part of the drilling riser assembly. During drilling operations, drilling fluid, or mud, is delivered through the drill string, and returned up an annulus between the drill string and casing that lines the well bore.

In producing oil and gas from offshore wells, the wellhead is employed at the seafloor and the hydrocarbons flow from the wellhead through tubular producing risers to the surface where the fluids are collected in a receiving facility located on a platform or other vessel. Normally, the flow of hydrocarbons is controlled via a series of valves installed on the wellhead, the risers, and in the receiving facility at the surface. At times, temporary flow lines from the wellhead to a receiving facility may be installed.

Though the sea floor may be 5,000-7,000 feet or more below the surface and include pressures at or exceeding 2,000 p.s.i., many different types of equipment and tools are needed at the subsea wellhead and inside the well bore to support drilling operations, production operations, or remedial operations, such as if there is a well blowout, or flowline or valve failure due to excessive pressures. Because of the depth and pressures, effectuating repairs at such depths requires that equipment and tools be handled by deep diving, remotely operated vehicles (ROV's) which are essentially robots controlled by an operator in a surface vessel. Controlling the vehicles from such distances and using the ROV's to operate, repair and/or replace equipment and tools is a difficult and time consuming task. Therefore, it is desirable to operate such equipment and tools in an efficient manner. Many times, large power sources are required to efficiently operate the equipment and tools. Accordingly, there remains a need in the art for systems and methods to provide large power sources, particularly hydraulic power, to subsea and downhole equipment and tools.

### SUMMARY

Embodiments of a subsea accumulator system are disclosed. In some embodiments, a subsea accumulator system includes a subsea skid structure, a pre-charged fluid accumulator mounted in the subsea skid structure and fluidly coupled to a flowline in the skid structure, and a subsea device coupled to the flowline to receive hydraulic fluid power from the pre-charged fluid accumulator. The fluid accumulator may include an internal separation member between a first side to receive a pre-charge fluid and a second side to receive a hydraulic fluid, and the internal separation member may be a piston. The system may include a fill port having a releasable connection to selectively couple with a hydraulic fluid supply separate from the skid structure.

In some embodiments, the system may include a first bank of a plurality of pre-charged fluid accumulators fluidly coupled to the flowline. A first pre-charged fluid accumulator may be configured to receive a first fluid and a second pre-charged fluid accumulator may be configured to receive a second fluid. The first and second pre-charged fluid accumulators may be actuatable to discharge the first and second fluids substantially simultaneously and mix the first and second fluids in the flowline. The first and second pre-charged fluid accumulators may be actuatable to discharge the first and second fluids sequentially through the flowline. The subsea skid structure may be stand-alone and apart from a BOP.

In some embodiments, a subsea accumulator system includes a subsea skid structure including a landing arrangement, a control panel, and a fluid delivery flowline, a hydraulic fluid accumulator mounted in the subsea skid structure, wherein the hydraulic fluid accumulator includes an internal piston separating a pre-charged fluid chamber and a hydraulic fluid chamber that is coupled to the fluid delivery flowline, a subsea device coupled to the fluid delivery flowline to receive hydraulic fluid from the hydraulic fluid chamber of the hydraulic fluid accumulator, and a valve coupled into the delivery flowline to control the flow rate of the hydraulic fluid delivered to the subsea device.

In some embodiments, a method of providing hydraulic fluid power to a subsea system includes deploying an accumulator skid structure near a subsea wellhead, coupling a subsea device to an outlet of a delivery flowline in the skid structure, and exposing the subsea device to a pre-charged hydraulic fluid accumulator to deliver a hydraulic fluid through the delivery flowline to the subsea device. The method may further include pre-charging at a sea surface the accumulator to a first predetermined pressure. The method may further include loading the pre-charged accumulator with a hydraulic fluid until a second predetermined pressure is reached. The method may further include moving a piston in the fluid accumulator to deliver the hydraulic fluid by allowing a pre-charge fluid to expand. The method may include connecting a hydraulic fluid supply to a fill port coupled into the delivery flowline, and re-supplying a hydraulic fluid chamber of the fluid accumulator using the hydraulic fluid supply. The method may further include disconnecting the hydraulic fluid supply from the fill port, moving the skid structure to another location near the subsea wellhead, and re-connecting the hydraulic fluid supply to the fill port.

In some embodiments, a subsea accumulator system includes a subsea skid structure, a first fluid accumulator mounted in the subsea skid structure, the first fluid accumulator including a first piston having a first side and a second side containing a first fluid, a second fluid accumulator mounted in the subsea skid structure, the second fluid accumulator including a second piston having a first side and a second side containing a second fluid, a subsea device fluidly coupled to a flowline in the skid structure, the flowline fluidly coupled to the second sides of the first and second pistons, and wherein the flowline is configured to receive the first and second fluids from the first and second fluid accumulators. The system may include a subsea pump coupled to at least one of the first and second fluid accumulators, wherein the subsea pump is coupled to the first side of the accumulator piston to pressurize at least one of the first and second fluids. At least one of the first and second fluid accumulators may include a pre-charged fluid on the first side of the accumulator piston to pressurize at least one of the first and second fluids. The first and second accumulators may be configured to discharge the first and second fluids substantially simultaneously and mix the first and second fluids in the flowline. The first and second accumulators may be configured to discharge the first and second fluids sequentially in the flowline.

In some embodiments, a method of providing fluid to a subsea system includes deploying an accumulator skid structure near a subsea wellhead, coupling a subsea device to an outlet of a delivery flowline in the skid structure, pressurizing a piston in a first fluid accumulator in the skid structure to discharge a first fluid to the delivery flowline, and pressurizing a piston in a second fluid accumulator in the skid structure to discharge a second fluid to the delivery flowline. The method may include pressurizing the first and second pistons using a subsea pump coupled to the first and second fluid accumulators. The method may include pressurizing the first and second pistons by pre-charging the first and second fluid accumulators.

In some embodiments, a subsea accumulator system includes a subsea skid structure, a fluid accumulator mounted in the subsea skid structure and fluidly coupled to a flowline in the skid structure, the fluid accumulator including an internal piston with a first side and a second side to receive a hydraulic fluid, an inlet coupled to the first side of the piston to receive a pressurized fluid from a subsea pump, and a subsea device coupled to the flowline to receive hydraulic fluid power from the second side of the piston in response to a pressurized fluid from the subsea pump on the first side of the piston. In some embodiments, a method of providing a fluid to a subsea system includes deploying an accumulator skid structure near a subsea wellhead, coupling a subsea device to an outlet of a delivery flowline in the skid structure, coupling a subsea pump to an inlet of a fluid accumulator in the skid structure, pumping a first fluid from the subsea pump to a first side of a piston in the fluid accumulator, and discharging a second fluid from a second side of the piston in the fluid accumulator to the subsea device in response to the pumped first fluid.

Thus, embodiments described herein comprise a combination of features and advantages intended to address various shortcomings associated with certain prior devices, systems, and methods. The various characteristics described above, as well as other features, will be readily apparent to those skilled in the art upon reading the following detailed description, and by referring to the accompanying drawings.

### BRIEF DESCRIPTION OF THE DRAWINGS

For a detailed description of exemplary embodiments of the invention, reference will now be made to the accompanying drawings in which:

FIG. 1 is a schematic view of an exemplary offshore drilling system;

FIG. 2 is schematic view of an exemplary subsea hydrocarbon recovery system;

FIG. 3 is an isometric view of an accumulator system in accordance with principles taught herein;

FIG. 4 is another view of the accumulator system of FIG. 3;

FIG. 5 is a side view of the accumulator system of FIGS. 3 and 4;

FIG. 6 is a front view of the accumulator system of FIGS. 3-5 showing the main ROV control panel;

FIG. 7 is a back view of the accumulator system of FIGS. 3-6 showing the rear ROV panel;

FIG. 8 is a hydraulic schematic of the accumulator system of FIGS. 3-7;

FIG. 9 is a simplified hydraulic schematic of another hydraulic accumulator system embodiment based on the accumulator system of FIGS. 3-8;

FIG. 10 is a simplified hydraulic schematic of yet another hydraulic accumulator system embodiment using a subsea pump;

FIG. 11 is a simplified hydraulic schematic of still another hydraulic accumulator system embodiment using multiple accumulator banks; and

FIG. 12 is a flowchart illustrating an exemplary embodiment of a method for providing hydraulic fluid power to a subsea system.

### DETAILED DESCRIPTION

In the drawings and description that follow, like parts are typically marked throughout the specification and drawings with the same reference numerals, respectively. Certain terms are used throughout the description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components may be shown exaggerated in scale or in somewhat schematic form and some details of conventional elements may not be shown in the interest of clarity and conciseness. The present invention is susceptible to embodiments of different forms. Specific embodiments are described in detail and are shown in the drawings, with the understanding that the present disclosure is to be considered an exemplification of the principles of the invention, and is not intended to limit the invention to that illustrated and described herein. It is to be fully recognized that the different teachings of the embodiments discussed below may be employed separately or in any suitable combination to produce desired results.

The terms “including” and “comprising” are used in an open-ended fashion, and thus should be interpreted to mean “including, but not limited to . . . .” Unless otherwise specified, any use of any form of the terms “couple”, “attach”, “connect” or any other term describing an interaction between elements is not meant to limit the interaction to direct interaction between the elements and may also include indirect interaction between the elements described. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. As used herein, the term “flowline” refers to any tubing, piping, fluid conduit or other plumbing that fluidly couples various portions of systems described herein.

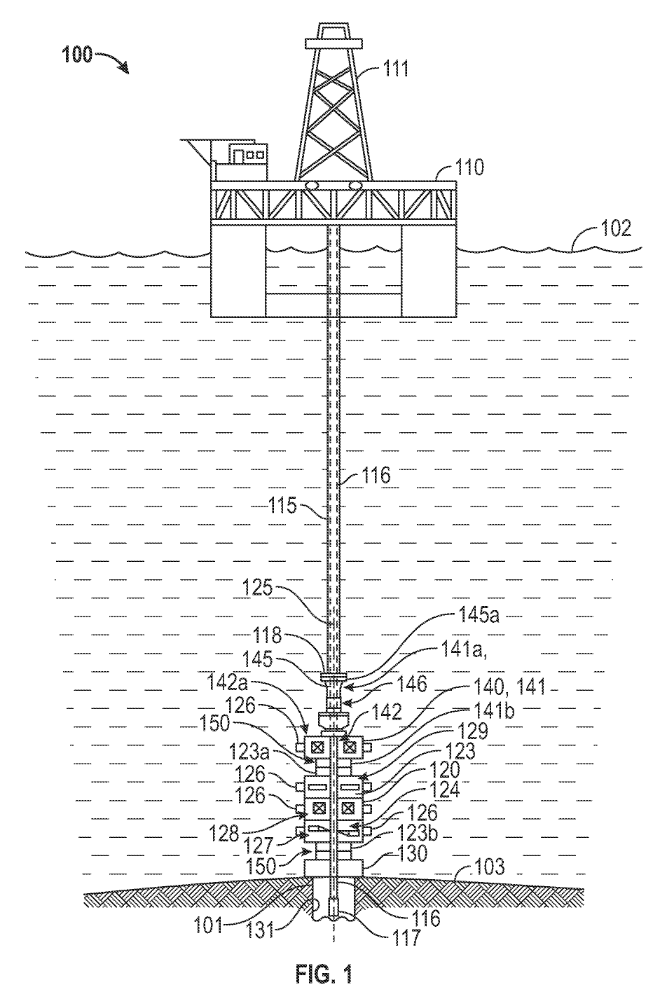

Referring initially to FIG. 1, an embodiment of an offshore system 100 for drilling and/or producing a wellbore 101 is shown. In this embodiment, system 100 includes an offshore platform 110 at the sea surface 102, a subsea blowout preventer (BOP) 120 mounted to a wellhead 130 at the sea floor 103, and a lower marine riser package (LMRP) 140. Platform 110 is equipped with a derrick 111 that supports a hoist (not shown). A drilling riser 115 extends from platform 110 to LMRP 140. In general, riser 115 is a large-diameter pipe that connects LMRP 140 to the floating platform 110. During drilling operations, riser 115 takes mud returns to the sea surface 102. Casing 131 extends from wellhead 130 into subterranean wellbore 101.

Downhole operations are carried out by a tubular string 116 (e.g., drillstring, production tubing string, coiled tubing, etc.) that is supported by derrick 111 and extends from platform 110 through riser 115, LMRP 140, BOP 120, and into cased wellbore 101. A downhole tool 117 is connected to the lower end of tubular string 116. In general, downhole tool 117 may comprise any suitable downhole tool(s) for drilling, completing, evaluating and/or producing wellbore 101 including, without limitation, drill bits, packers, testing equipment, perforating guns, and the like. These tools may require power sources for operation, such as electrical or hydraulic. The power source may be self-contained, such as a tool battery, or provided through a line to the surface of the sea. Often, there are limits to the amount of power these sources can provide, and they are insufficient for particular applications. During downhole operations, string 116, and hence tool 117 coupled thereto, may move axially, radially, and/or rotationally relative to riser 115, LMRP 140, BOP 120, and casing 131.

BOP 120 and LMRP 140 are configured to controllably seal wellbore 101 and contain hydrocarbon fluids therein. Specifically, BOP 120 has a central or longitudinal axis 125 and includes a body 123 with an upper end 123a releasably secured to LMRP 140, a lower end 123b releasably secured to wellhead 130, and a main bore 124 extending axially between upper and lower ends 123a, b. Main bore 124 is coaxially aligned with wellbore 101, thereby allowing fluid communication between wellbore 101 and main bore 124. BOP 120 may be releasably coupled to LMRP 140 and wellhead 130 with hydraulically actuated, mechanical wellhead-type connectors 150. In general, connectors 150 may comprise any suitable releasable wellhead-type mechanical connector such as the H-4® profile subsea connector available from VetcoGray Inc. of Houston, Tex. or the DWHC profile subsea connector available from Cameron International Corporation of Houston, Tex. Typically, such wellhead-type mechanical connectors (e.g., connectors 150) comprise a male component or coupling that is inserted into and releasably engages a mating female component or coupling. In addition, BOP 120 includes a plurality of axially stacked sets of opposed rams—opposed blind shear rams or blades 127 for severing tubular string 116 and sealing off wellbore 101 from riser 115 and opposed pipe rams 128, 129 for engaging string 116 and sealing the annulus around tubular string 116, and may include opposed blind rams 128 for sealing off wellbore 101 when no string (e.g., string 116) or tubular extends through main bore 124. Each set of rams 127, 128, 129 is equipped with sealing members that engage to prohibit flow through the annulus around string 116 and/or main bore 124 when rams 127, 128, 129 are closed.

Opposed rams 127, 128, 129 are disposed in cavities that intersect main bore 124 and support rams 127, 128, 129 as they move into and out of main bore 124. Each set of rams 127, 128, 129 is actuated and transitioned between an open position and a closed position. In the open positions, rams 127, 128, 129 are radially withdrawn from main bore 124 and do not interfere with tubular string 116 or other hardware that may extend through main bore 124. However, in the closed positions, rams 127, 128, 129 are radially advanced into main bore 124 to close off and seal main bore 124 (e.g., rams 127, 128) or the annulus around tubular string 116 (e.g., rams 129). Each set of rams 127, 128, 129 is actuated and transitioned between the open and closed positions by a pair of actuators 126. In particular, each actuator 126 hydraulically moves a piston within a cylinder to move a drive rod coupled to one ram 127, 128, 129. Actuators 126 are further examples of subsea equipment that require power supplies, in this case hydraulic. The power needed to move rams 127, 128, 129 to accomplish the required task can be quite large.

BOP 120 may include three sets of rams (one set of shear rams 127, two sets of pipe rams 128, 129); however, the BOP (e.g., BOP 120) may include a different number of rams (e.g., four sets of rams), different types of rams (e.g., two sets of shear rams), an annular BOP (e.g., an annular BOP 142a), or combinations thereof. Likewise, although LMRP 140 is shown and described as including one annular BOP 142a, the LMRP (e.g., LMRP 140) may also include a different number of annular BOPs (e.g., two sets of annular BOPs), different types of rams (e.g., shear rams), or combinations thereof. Consequently, various ranges of subsea hydraulic power may be needed.

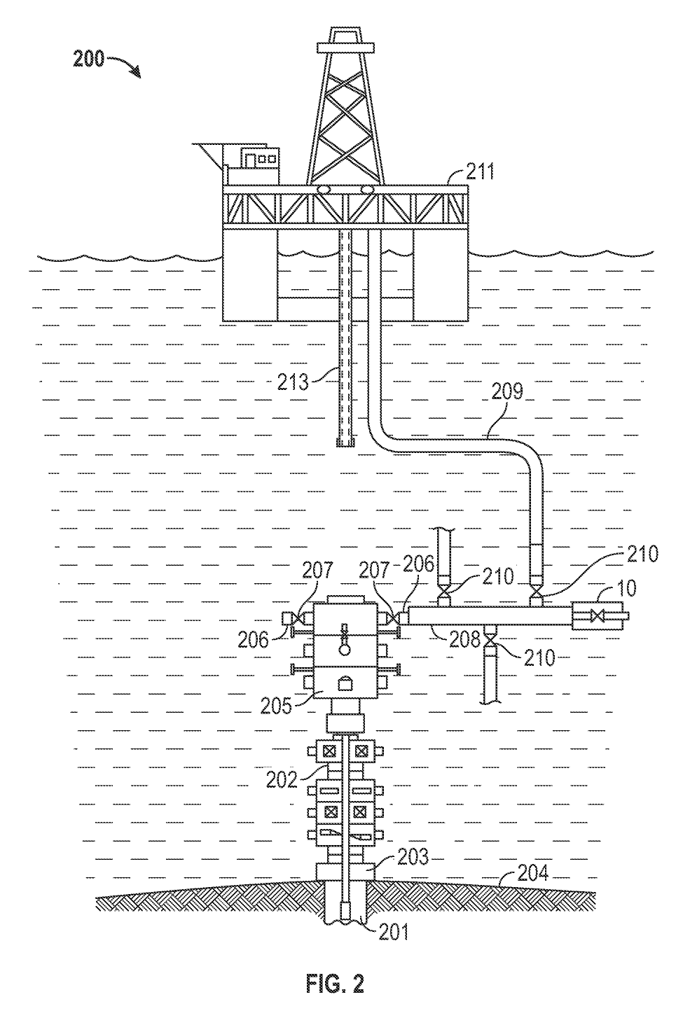

Referring next to FIG. 2, an exemplary embodiment of an offshore system 200 for recovering hydrocarbons from a subsea wellbore 201 is shown. In this embodiment, system 200 includes a blowout preventer (BOP) 202 mounted to a wellhead 203 at the sea floor 204, and a capping stack 205 mounted atop BOP 202. In a typical system for producing from well 201, hydrocarbons are allowed to flow through the BOP 202, through a lower marine riser package (not shown), and through risers 213 to a hydrocarbon-receiving vessel at the surface, such as platform 211. In this example, however, capping stack 205 has been substituted for a lower marine riser package in a situation, for example, where hydrocarbon flow is not controlled via the normal path and is instead diverted and collected via an alternate collection system.

Capping stack 205 includes at least one fluid outlet 206 controlled by a valve 207 for controlling the flow of hydrocarbons from the well to various destinations, including into a distribution manifold 208. In turn, one or more flowlines 209 are connected to valved outlets 210 in the manifold 208 and are employed to transport the hydrocarbons from the well to one or more hydrocarbon storage vessels at the surface, such as platform 211. A pressure relief valve 10 is coupled to subsea manifold 208 and is in fluid communication with hydrocarbons contained in manifold 208. When valved outlet 210 interconnecting flowline 209 and manifold 208 is open, pressure relief valve 10 is likewise in fluid communication with flow line 209. Various subsea equipment in a subsea operation may require large amounts of hydraulic power, such as without limitation, any type of ROV tool or the valve operators in the capping stack or the BOP.

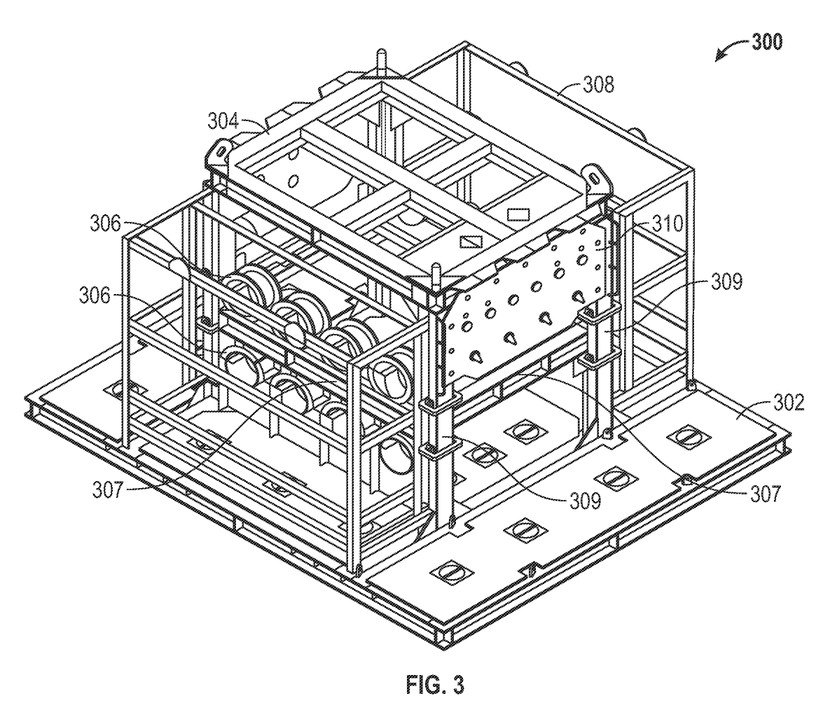

Embodiments of a subsea hydraulic accumulator system will now be described. Generally, the subsea hydraulic accumulator system is delivered to an area near a subsea wellhead so that the hydraulic power contained therein can be supplied to wellhead or downhole equipment or tools. Referring now to FIG. 3, a stand-alone subsea hydraulic accumulator system 300 is shown isometrically. The system 300, also referred to as an accumulator skid, includes a base 302 and a frame or support structure 304 mounted thereon. The base 302 and support structure 304 are separate from, or “stand-alone” relative to, other structures and skids at the sea floor. Furthermore, the base 302 includes a landing arrangement, such as mud mats and a pile, to facilitate standing alone at the sea floor and apart from the BOP. Together, the base 302 and the frame 304 may also be referred to as a skid structure. An intermediate portion of the frame 304 includes a plurality of accumulator supports or holders 306. Mounted on two sides of the base 302 and the frame 304 are frames 308 for attaching protective covers or cages (not shown) adjacent the ends of the accumulators. An ROV control panel is mounted on another side of the frame 304.

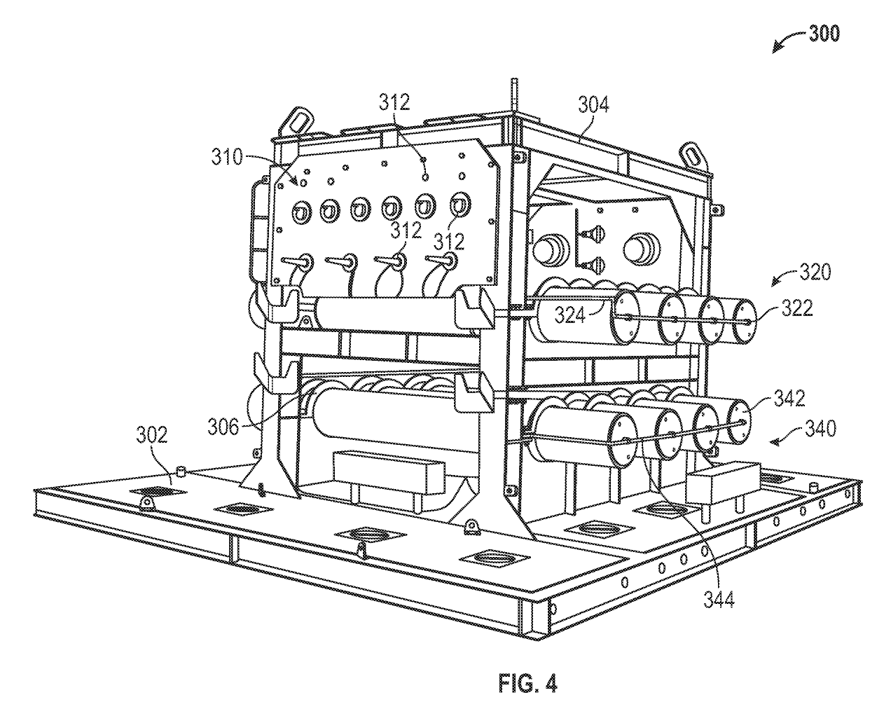

Referring next to FIG. 4, the accumulator system 300 is shown with accumulators installed. An accumulator is a device used in a hydraulic system to store energy. Energy is stored by compressing a pre-charged gas chamber with hydraulic fluid from the operating or charging system. Depending on the fluid volume and the pre-charge pressure of the accumulator, a limited amount of hydraulic energy is then available from the accumulator independent of any other power source. Exemplary accumulators include piston-type accumulators, bladder-type accumulators, compressed gas accumulators, spring-type accumulators, raised weight accumulators, and metal bellows type accumulators. Another exemplary accumulator is described in U.S. Pat. No. 6,202,753 and incorporated herein by reference.

The accumulator holders 306 support a first bank 320 of accumulators 322 and a second bank 340 of accumulators 342. As will be understood, the number of banks and accumulators may vary according to the amount of hydraulic power desired. The accumulator banks are operable separately, and provide redundancy with a plurality of parallel-connected accumulators in each bank. The accumulators 322 are fluidly coupled to each other and to the ROV panel 310 and support frame 304 by flowlines 324. Similarly, the accumulators 342 are fluidly coupled to each other and to the ROV panel 310 and support frame 304 by flowlines 344. The ROV panel 310 includes a plurality of hydraulic connections, gauges and valves 312 for operating the system 300.

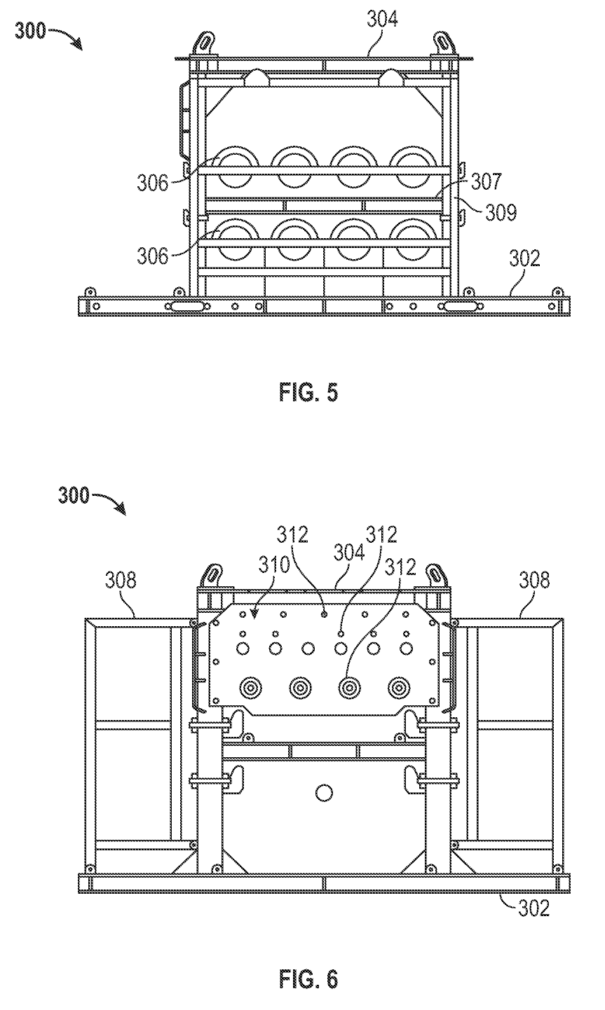

Referring to FIG. 5, a side view of the accumulator skid 300 shows the accumulator supports 306 in the main frame 304. In some embodiments, the number of accumulators 322 in the system 300 can be increased. An intermediate frame 307 (see also FIG. 3) disposed between the rows of accumulator supports 306 (each row supporting an accumulator bank 320, 340) allows additional such intermediate frames to be stacked vertically to add more accumulators 322 and accumulator banks 320, 340 as desired. Vertical supports 309 of the main frame 304 can be extended vertically to accommodate additional intermediate frames 307 having additional accumulators 322 and accumulator banks 320, 340.

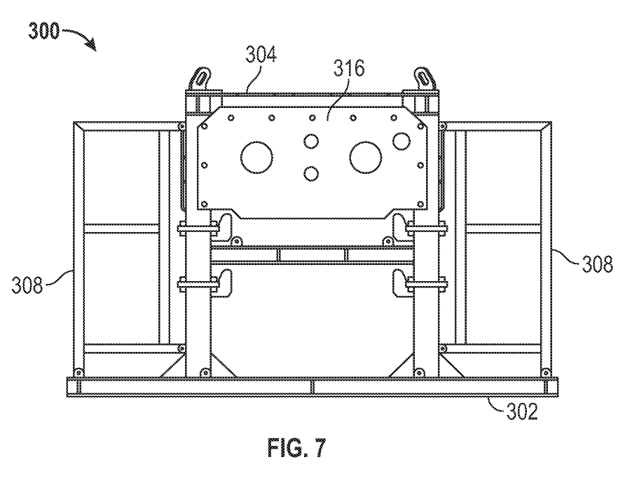

In FIG. 6, the main ROV control panel 310 is shown including the various connections, or hot stabs, gauges and valves 312. In FIG. 7, a rear ROV panel is shown including additional connections and controls.

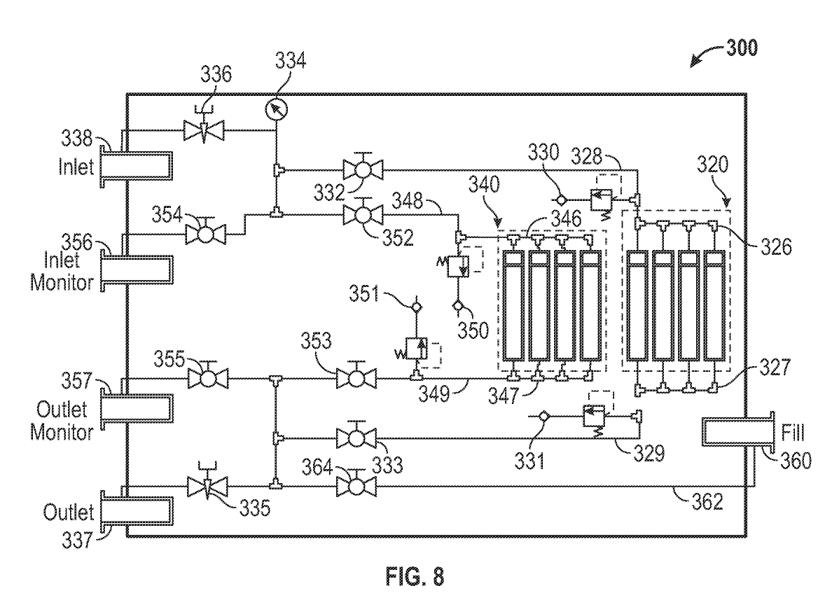

Referring now to FIG. 8, a hydraulic schematic of the system 300 is shown. The first accumulator bank 320 includes an inlet side 326 coupled to an inlet tubing or flowline 328 having an isolation valve 332 for isolating the accumulator bank 320. Coupled into the inlet flowline 328 is a safety pressure relieve valve 330, so that the systems described herein are protected from overpressure situations. The second accumulator bank 340 has a similar arrangement, including an inlet side 346, an inlet flowline 348 and an isolation valve 352. Coupled into inlet flowline 348 is a safety pressure relief valve 350. On the other side of the isolation valves 332, 352 are an inlet 338, which is one of the hot stab connections on the ROV panel 310, a flow control valve 336, a pressure gauge 334, an inlet monitor 356, and a valve 354. On the other side of the accumulator banks 320, 340 are outlet sides 327, 347 including outlet flowlines 329, 349, safety pressure relief valves 331, 351, and isolation valves 333, 353. On the other side of the isolation valves 333, 353 are an outlet 337, a flow control valve 335, an outlet monitor 357, and a valve 355. In some embodiments, the flow control valves 335, 336 are needle valves because needle valves provide variable flow control, rather than simple on/off control, and they react well under pressure when regulating flow.

Also coupled into the outlet side of the accumulator banks 320, 340 is a supply or fill port 360 including a supply flowline 362 and an isolation valve 364. As will be described more fully below, the fill port 360 can be used to re-supply the outlet sides or chambers of the accumulators 322, 342 (FIG. 4). As will also be clear, the fill port 360 and the other fill ports described herein are used to repeatedly and quickly refill the accumulators while subsea.

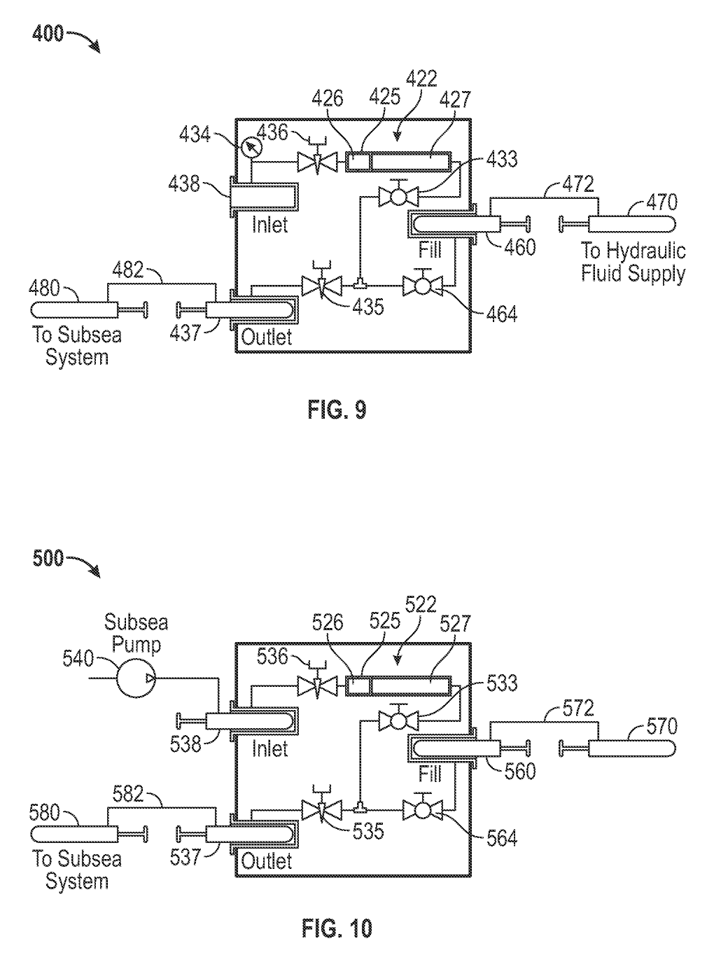

Referring now to FIG. 9, a simplified hydraulic schematic of an exemplary hydraulic accumulator system 400 is shown based on the principles described above. In operation, a back or inlet side 426 of an accumulator 422 is pressured up or pressurized using nitrogen, also called pre-charging, at the surface. The pre-charge fluid may also be, without limitation, other inert gases. An inlet 438 may be used to pre-charge the accumulator 422, and a gauge 434 and a needle valve 436 may be used to monitor the process. The system 400 is then deployed to the sea floor 103, 204 near the wellhead 130, 203. In exemplary embodiments, “near” the wellhead means within tens or hundreds of feet of the wellhead. A piston 425 separates the inlet side chamber 426 from an outlet side chamber 427. Hydraulic fluid may then be added to a front or outlet side 427 of the accumulator 422 using a fill port 460. The fill port 460 may be a hot stab receptacle in the ROV panel 310 that is connectable to a hydraulic fluid supply 470 via a supply line 472. The fluid supply 470 may be at the surface, where large volumes of hydraulic fluid can be maintained. Hydraulic fluid is added to the outlet side 427 of the accumulator until a second or hydraulic fluid predetermined pressure is reached and the valve 464 is closed. By way of example only, the accumulator 422 may be pre-charged at the surface with nitrogen or other similar fluid to about 3,000 p.s.i., and when the system 400 is deployed at depth the ambient pressure becomes about 2,450 p.s.i., for example, making the new pressure differential, as measured by the gauge 434, approximately 550 p.s.i. In other exemplary embodiments, the accumulator 422 may be pre-charged at the surface to about 3,000 p.s.i., and after deploying the system 400 to about 5,000 feet where ambient pressure is about 2,225 p.s.i., the new differential pressure as measured by the gauge 434 is approximately 775 p.s.i. The above conditions and pressures are given as illustrative examples only and are not limiting.

The system 400, once charged, can now be used to deliver large volumes of hydraulic fluid at pressure to a subsea device or system 480, such as a BOP operating valve or a downhole tool, by opening a valve 433 and/or valve 435 and allowing the hydraulic fluid outlet side 427 to communicate with an outlet receptacle 437 and the subsea device 480 via a delivery flowline 482. The total volume of hydraulic fluid delivered by the system 400 can be accurately estimated from noting the nitrogen pressures before and after the hydraulic fluid is delivered. By also knowing the geometry, volume and configuration of the accumulator skid components, the volume of hydraulic fluid delivered can be calculated. For example, 50 gallons of delivered hydraulic fluid can be estimated to within an error of 1 gallon, or two percent error. In some embodiments, knowing the volume of hydraulic fluid delivered is important for confirming that the subsea system 480 was properly actuated. Further, a flow control valve 435, such as a needle valve, can be used to control, manage or limit the flow rate of hydraulic fluid to the subsea device 480. In certain embodiments, the pre-charged, piston-type accumulators 422 can be banked to provide large volume, large flow sources of hydraulic fluid that are controlled to be applicable to a wide range of subsea systems.

After the hydraulic fluid outlet side 427 has been depleted, it can be re-supplied via the fill system 460, 470. The valve 464 is opened and the accumulator 422 is re-supplied with hydraulic fluid from the supply source 470. In other embodiments, the supply line 472 can be detached from the fill port 460, the system 400 moved via the skid structure, and the supply line 472 re-attached to the fill port 460 at the new location. Hydraulic power delivery and refill procedures may then be repeated as necessary.

In another embodiment, and with reference to FIG. 10, an accumulator system 500 includes similar components to system 400 with a few changes. Instead of an inlet 438 configured for pre-charging the accumulator 422 at the surface, an inlet 538 is coupled to a subsea pump 540. Subsea pump 540 may be any pump known to those of skill in the art. Accumulators 522 are pre-loaded with hydraulic fluid via a fill receptacle 560, either at the surface or on-bottom. The system 500 is deployed and the subsea pump 540 is actuated to supply pressure to a back side 526 of a piston 525 to move the piston forward, thereby forcing the hydraulic fluid into a desired subsea device 580. The delivery flow rate can be regulated with either needle valve 535, 536. As with system 400, the system 500 can be replenished subsea using the fill system 560, 572, 570.

In certain embodiments, the back side 526 of the accumulator 522 is open such that a ROV or other similar device can pressurize the piston 525, making the accumulator 522 work as a syringe. The ability to use a ROV or other hydraulic pressure source to pressurize the back side 526 of the accumulator 522 allows the accumulator 522 and the system 500 to work at various depths having various ambient pressures without being dependent on the changing ambient pressures.

The system 500 may also be repositioned by de-coupling the fill system, moving the accumulator skid to a desired location, and re-coupling the fill system. In certain embodiments, the system 500 is compatible with chemicals instead of hydraulic fluid, such as fluids used in completion or production procedures such as, without limitation, methanol or sealants. The subsea pump 540 is separated from the chemicals by the piston-type accumulator 522, thus a chemical compatible pump is not needed. Also, chemical delivery is typically less demanding than hydraulic fluid delivery, thus the subsea pump 540 may also be used for the process of delivering chemicals. In some embodiments, the system 500 (as well as systems 300, 400, and 600) is subsea re-configurable between hydraulic delivery and chemical delivery by switching between supplying these different fluids as desired.

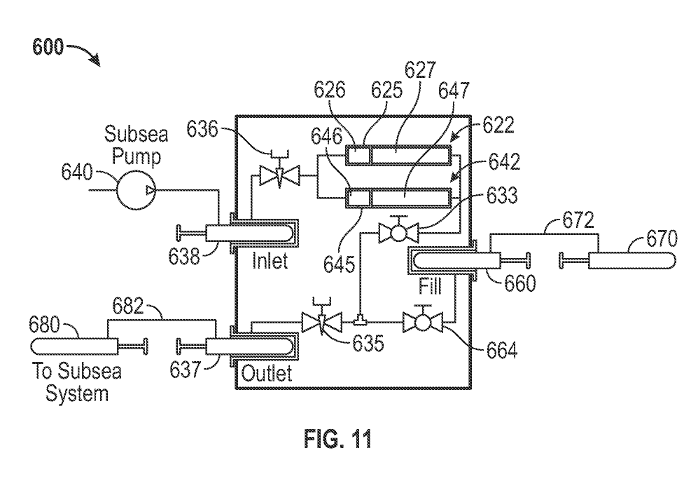

In yet another embodiment, and with reference to FIG. 11, an accumulator system 600 includes similar components to systems 400, 500 with a few changes. An accumulator 622 is coupled in parallel with an accumulator 642. In some embodiments, the accumulators 622, 642 are loaded with hydraulic fluid and the accumulators serve as backups to each other for redundancy purposes. In other embodiments, the accumulator 622 is loaded with a first fluid or chemical and the accumulator 642 is loaded with a second fluid or chemical. The accumulators 622, 642 are loaded sequentially via a fill system 660, 672, 670. The system 600 is deployed and the subsea pump 640 is actuated to supply pressure to back sides 626, 646 of pistons 625, 645 to move the pistons forward substantially simultaneously, thereby forcing the chemicals out of the accumulators and into the common outlet flowline substantially simultaneously where the first and second fluids or chemicals mix before exiting via an outlet receptacle 637 and into a subsea device 680. The delivery flow rate can be regulated with either needle valve 635, 636. Alternatively, the separate fluids can be discharged sequentially, in which case the system can be used to carry a plurality of fluids and selectively deliver them in the subsea environment. In some embodiments, the accumulators 622, 642 are powered or driven by a pre-charge as described with respect to system 400 and FIG. 9, instead of by the subsea pump 640.

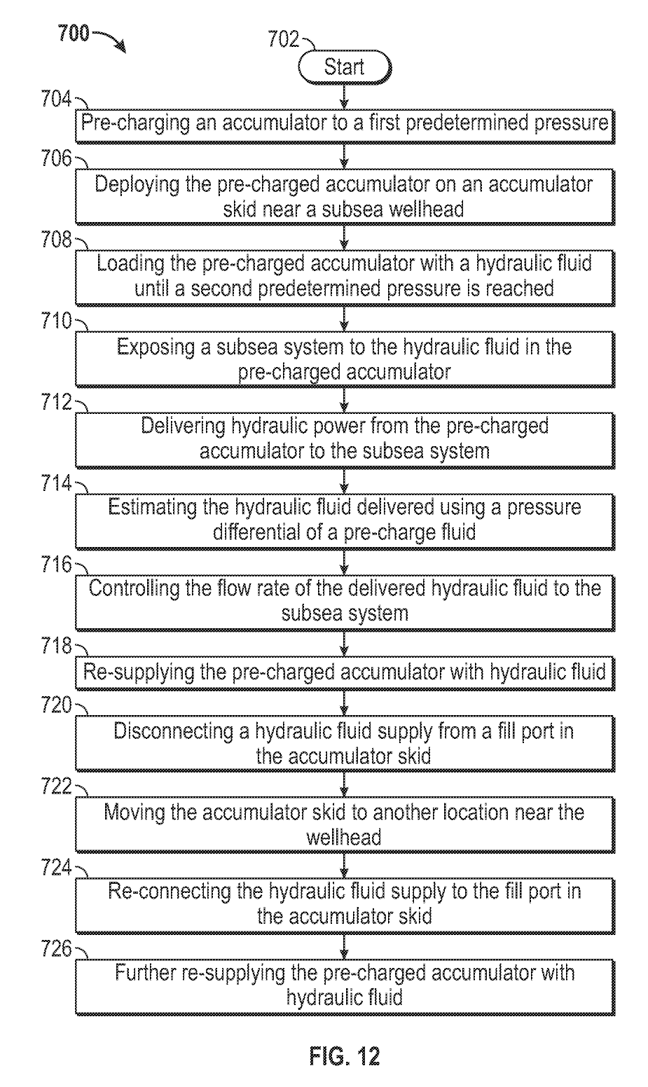

Referring now to FIG. 12, a flow chart shows a representative process 700 for deploying and using a hydraulic accumulator system with pre-charged accumulators and a fill port sub-system. At 704, an accumulator or series of accumulators in one or more banks of accumulators is pre-charged to a first or pre-charge predetermined pressure. As previously mentioned, an exemplary pre-charge fluid is nitrogen, though other pre-charge fluids and inert gases are also known. At 706, the pre-charged accumulators on the accumulator skid are deployed to sea bottom near a wellhead where hydraulic power is needed. At 708, hydraulic fluid is added to the pre-charged accumulators to a second or hydraulic fluid predetermined pressure. At 710, a valve is opened to expose the hydraulic fluid side of the accumulator to the subsea system. At 712, the pressured pre-charge fluid pushes the piston toward the hydraulic fluid causing the hydraulic fluid to be delivered to the subsea system in the form of hydraulic power. At 714, the pressure differential of the pre-charge fluid before and after hydraulic fluid delivery can be used to estimate the volume of hydraulic fluid delivered, which may be useful in confirming actuation of the subsea system. At 716, the hydraulic fluid delivery to the subsea system can be controlled, to provide the appropriate amount of power to the subsea system and prevent destructive overpressure.

At 718, the fill port and system can be used to re-supply the accumulator with hydraulic fluid subsea. Further, at 720, the hydraulic fluid supply can be disconnected from the fill port. Then, the disconnected accumulator skid can be moved to another location subsea at 722. At 724, the accumulator skid is re-connected to the hydraulic fluid supply using the fill port and a connection at the end of the hydraulic fluid supply line. Now, the accumulators can be further re-supplied with hydraulic fluid at 726.

While specific embodiments have been shown and described, modifications can be made by one skilled in the art without departing from the scope or teachings herein. The embodiments as described are exemplary only and are not limiting. Many variations and modifications of the systems, apparatus, and processes described herein are possible and are within the scope of the invention. For example, the relative dimensions of various parts, the materials from which the various parts are made, and other parameters can be varied. Accordingly, the scope of protection is not limited to the embodiments described, but is only limited by the claims that follow, the scope of which shall include all equivalents of the subject matter of the claims.

What is claimed is:

1. A subsea accumulator system comprising:
a subsea skid structure;
a pre-charged fluid accumulator mounted in the subsea skid structure and fluidly coupled to a flowline in the skid structure; and
a subsea device coupled to the flowline to receive hydraulic fluid power from the pre-charged fluid accumulator.

2. The system of claim 1 wherein the fluid accumulator includes an internal separation member between a first side to receive a pre-charge fluid and a second side to receive a hydraulic fluid.

3. The system of claim 2 wherein the internal separation member is a piston.

4. The system of claim 2 wherein the pre-charge fluid is added at a sea surface to the accumulator, and the hydraulic fluid is added subsea.

5. The system of claim 2 wherein the pre-charge fluid is nitrogen.

6. The system of claim 1 further comprising a fill port having a releasable connection to selectively couple with a hydraulic fluid supply separate from the skid structure.

7. The system of claim 6 wherein the fill port couples to the flowline and a hydraulic side of the fluid accumulator.

8. The system of claim 1 further comprising a control panel on the skid structure for controlling the hydraulic fluid power supply to the subsea device.

9. The system of claim 1 wherein the subsea device is at least one of a downhole tool or valve operator requiring hydraulic power.

10. The system of claim 1 further comprising a first bank of a plurality of pre-charged fluid accumulators fluidly coupled to the flowline.

11. The system of claim 10 further comprising a second bank of a plurality of pre-charged fluid accumulators fluidly coupled to a separate flowline.

12. The system of claim 10 wherein a first pre-charged fluid accumulator is configured to receive a first fluid and a second pre-charged fluid accumulator is configured to receive a second fluid.

13. The system of claim 12 wherein the first and second pre-charged fluid accumulators are actuatable to discharge the first and second fluids substantially simultaneously and mix the first and second fluids in the flowline.

14. The system of claim 12 wherein the first and second pre-charged fluid accumulators are actuatable to discharge the first and second fluids sequentially through the flowline.

15. The system of claim 1 wherein the subsea skid structure is stand-alone and apart from a BOP.

16. A subsea accumulator system comprising:
a subsea skid structure including a landing arrangement, a control panel, and a fluid delivery flowline;
a hydraulic fluid accumulator mounted in the subsea skid structure, wherein the hydraulic fluid accumulator includes an internal piston separating a pre-charged fluid chamber and a hydraulic fluid chamber that is coupled to the fluid delivery flowline;
a subsea device coupled to the fluid delivery flowline to receive hydraulic fluid from the hydraulic fluid chamber of the hydraulic fluid accumulator; and
a valve coupled into the delivery flowline to control the flow rate of the hydraulic fluid delivered to the subsea device.

17. The system of claim 16 further comprising a fill port in the control panel coupled to the delivery flowline to receive a hydraulic supply line.

18. The system of claim 16 wherein the subsea skid structure is stand-alone and apart from a BOP.

19. A method of providing hydraulic fluid power to a subsea system, comprising:
deploying an accumulator skid structure near a subsea wellhead;
coupling a subsea device to an outlet of a delivery flowline in the skid structure; and
exposing the subsea device to a pre-charged hydraulic fluid accumulator to deliver a hydraulic fluid through the delivery flowline to the subsea device.

20. The method of claim 19 further comprising pre-charging at a sea surface the accumulator to a first predetermined pressure.

21. The method of claim 20 further comprising loading the pre-charged accumulator with a hydraulic fluid until a second predetermined pressure is reached.

22. The method of claim 19 further comprising moving a piston in the fluid accumulator to deliver the hydraulic fluid by allowing a pre-charge fluid to expand.

23. The method of claim 19 further comprising estimating the hydraulic fluid delivered using a pressure differential of a pre-charge fluid.

24. The method of claim 19 further comprising controlling a flow rate of the hydraulic fluid to the subsea device.

25. The method of claim 19 further comprising connecting a hydraulic fluid supply to a fill port coupled into the delivery flowline.

26. The method of claim 25 further comprising re-supplying a hydraulic fluid chamber of the fluid accumulator using the hydraulic fluid supply.

27. The method of claim 25 further comprising:
disconnecting the hydraulic fluid supply from the fill port;
moving the skid structure to another location near the subsea wellhead; and
re-connecting the hydraulic fluid supply to the fill port.

28. The method of claim 19 wherein the skid structure is stand-alone and apart from a BOP.

29. The method of claim 19 further comprising exposing the subsea device to a first pre-charged hydraulic fluid accumulator containing a first fluid and a second pre-charged hydraulic fluid accumulator containing a second fluid to discharge the first and second fluids substantially simultaneously and mix the first and second fluids in the delivery flowline.

30. The method of claim 19 further comprising exposing the subsea device to a first pre-charged hydraulic fluid accumulator to discharge a first fluid, and exposing the subsea device to a second pre-charged hydraulic fluid accumulator to discharge a second fluid sequentially with the first fluid through the delivery flowline.

31. A subsea accumulator system comprising:
a subsea skid structure;
a first fluid accumulator mounted in the subsea skid structure, the first fluid accumulator including a first piston having a first side and a second side containing a first fluid;
a second fluid accumulator mounted in the subsea skid structure, the second fluid accumulator including a second piston having a first side and a second side containing a second fluid;
a subsea device fluidly coupled to a flowline in the skid structure, the flowline fluidly coupled to the second sides of the first and second pistons; and
wherein the flowline is configured to receive the first and second fluids from the first and second fluid accumulators.

32. The system of claim 31 further comprising a subsea pump coupled to at least one of the first and second fluid accumulators, wherein the subsea pump is coupled to the first side of the accumulator piston to pressurize at least one of the first and second fluids.

33. The system of claim 31 wherein at least one of the first and second fluid accumulators includes a pre-charged fluid on the first side of the accumulator piston to pressurize at least one of the first and second fluids.

34. The system of claim 31 wherein the first and second accumulators are configured to discharge the first and second fluids substantially simultaneously and mix the first and second fluids in the flowline.

35. The system of claim 31 wherein the first and second accumulators are configured to discharge the first and second fluids sequentially in the flowline.

36. A method of providing fluid to a subsea system, comprising:
deploying an accumulator skid structure near a subsea wellhead;
coupling a subsea device to an outlet of a delivery flowline in the skid structure;
pressurizing a piston in a first fluid accumulator in the skid structure to discharge a first fluid to the delivery flowline; and
pressurizing a piston in a second fluid accumulator in the skid structure to discharge a second fluid to the delivery flowline.

37. The method of claim 36 wherein pressurizing the first and second pistons further comprises using a subsea pump coupled to the first and second fluid accumulators.

38. The method of claim 36 wherein pressurizing the first and second pistons further comprises pre-charging the first and second fluid accumulators.

39. The method of claim 36 further comprising discharging the first and second fluids substantially simultaneously to mix the first and second fluids in the flowline, and delivering the mixed first and second fluids to the subsea device.

40. The method of claim 36 further comprising discharging the first and second fluids sequentially in the flowline and to the subsea device.
